(19) United States
(12) Patent Application Publication
(10) Pub. No.: US 2023/0394881 A1
(43) Pub. Date: Dec. 7, 2023

(54) INFORMATION PROCESSING APPARATUS, INFORMATION PROCESSING METHOD, AND COMPUTER-READABLE NON-TRANSITORY STORAGE MEDIUM

(71) Applicant: NEC Corporation, Tokyo (JP)

(72) Inventors: Kyota HIGA, Tokyo (JP); Yasunori BABAZAKI, Tokyo (JP); Ryuhei ANDO, Tokyo (JP)

(73) Assignee: NEC Corporation, Tokyo (JP)

(21) Appl. No.: 18/202,769

(22) Filed: May 26, 2023

(30) Foreign Application Priority Data
Jun. 6, 2022 (JP) 2022-091612

(51) Int. Cl. G06V 40/20; G06V 10/77; G06V 10/778

(52) U.S. Cl. CPC G06V 40/20; G06V 10/7715; G06V 10/778

(57) ABSTRACT

An information processing apparatus includes at least one processor, and the at least one processor carries out: a detection process of detecting a person and an object based on sensor information; a recognition process of recognizing an action of the person based on a relevance between the person and the object; and a generation process of generating unsafety information pertaining to unsafety of the action with reference to a detection result and a recognition result.

This Nonprovisional application claims priority under U.S.C. § 119 on Patent Application No. 2022-091612 filed in Japan on Jun. 6, 2022, the entire contents of which are hereby incorporated by reference.

### TECHNICAL FIELD

The present invention relates to an information processing apparatus, an information processing method, and a computer-readable non-transitory storage medium.

### BACKGROUND ART

A technique has been disclosed which determines, in order to prevent an industrial accident, whether or not an operator is operating safely.

Patent Literature 1 discloses a safety determination apparatus for determining whether or not a hand of an operator and a target object overlap in an image region of an image captured by a camera that images along a line of sight of that operator. In a case where it has been determined that the hand and the target object overlap, the apparatus determines whether or not a predetermined condition indicating a situation where safety of an operation is not secured is satisfied.

### CITATION LIST

### Patent Literature

[Patent Literature 1]
Japanese Patent Application Publication, Tokugan, No. 2018-28524

### SUMMARY OF INVENTION

### Technical Problem

The safety determination apparatus disclosed in Patent Literature 1 only considers a hand of an operator and a target object as targets for determination. Therefore, in the safety determination apparatus disclosed in Patent Literature 1, it is impossible to determine safety of an operation based on factors (such as operation content, another operator, and another object) other than the hand of the operator and the target object.

An example aspect of the present invention is accomplished in view of the foregoing problems, and its example object is to provide a technique which makes it possible to improve safety of an action of a person.

### Solution to Problem

An information processing apparatus according to an example aspect of the present invention includes at least one processor, the at least one processor carrying out: a detection process of detecting a person and an object based on sensor information; a recognition process of recognizing an action of the person based on a relevance between the person and the object; and a generation process of generating unsafety information pertaining to unsafety of the action with reference to a detection result in the detection process and a recognition result in the recognition process.

An information processing method according to an example aspect of the present invention includes: detecting, by at least one processor, a person and an object based on sensor information; recognizing, by the at least one processor, an action of the person based on a relevance between the person and the object; and generating, by the at least one processor, unsafety information pertaining to unsafety of the action with reference to a detection result in the detecting and a recognition result in the recognizing.

A computer-readable non-transitory storage medium according to an example aspect of the present invention stores a program for causing a computer to function as an information processing apparatus, the program causing the computer to carry out: a detection process of detecting a person and an object based on sensor information; a recognition process of recognizing an action of the person based on a relevance between the person and the object; and a generation process of generating unsafety information pertaining to unsafety of the action with reference to a detection result in the detection process and a recognition result in the recognition process.

### Advantageous Effects of Invention

According to an example aspect of the present invention, it is possible to improve safety of an action of a person.

### BRIEF DESCRIPTION OF DRAWINGS

FIG. 1 is a block diagram illustrating a configuration of an information processing apparatus according to a first example embodiment of the present invention.

FIG. 2 is a flowchart illustrating a flow of an information processing method according to the first example embodiment of the present invention.

FIG. 3 is a schematic diagram illustrating an information processing system according to a second example embodiment of the present invention.

FIG. 4 is a block diagram illustrating a configuration of an information processing system according to the second example embodiment of the present invention.

FIG. 5 is a flowchart illustrating a flow of an information processing method carried out by the information processing apparatus according to the second example embodiment of the present invention.

FIG. 6 is a diagram illustrating an example of action identification information according to the second example embodiment of the present invention.

FIG. 7 is a diagram illustrating an example of a table which is referred to by a generation section according to the second example embodiment of the present invention.

FIG. 8 is a diagram illustrating an example of an image captured in the second example embodiment of the present invention.

FIG. 9 is a diagram illustrating another example of an image captured in the second example embodiment of the present invention.

FIG. 10 is a diagram illustrating still another example of an image captured in the second example embodiment of the present invention.

FIG. 11 is a diagram illustrating still another example of an image captured in the second example embodiment of the present invention.

FIG. 12 is a diagram illustrating still another example of an image captured in the second example embodiment of the present invention.

FIG. 13 is a diagram illustrating still another example of an image captured in the second example embodiment of the present invention.

FIG. 14 is a diagram illustrating still another example of an image captured in the second example embodiment of the present invention.

FIG. 15 is a diagram illustrating still another example of an image captured in the second example embodiment of the present invention.

FIG. 16 is a diagram illustrating an example of unsafety information which is output by an output section according to the second example embodiment of the present invention.

FIG. 17 is a diagram illustrating another example of unsafety information which is output by an output section according to the second example embodiment of the present invention.

FIG. 18 is a diagram illustrating still another example of unsafety information which is output by an output section according to the second example embodiment of the present invention.

FIG. 19 is a diagram illustrating an example of an image which is included in annotation information according to a variation of the present invention.

FIG. 20 is a diagram illustrating an example of information indicating a person and an object included in annotation information according to a variation of the present invention.

FIG. 21 is a diagram illustrating an example configuration of an inference model which is used by a recognition section according to a variation of the present invention.

FIG. 22 is a diagram illustrating an example of relevant information which is included in annotation information according to a variation of the present invention.

FIG. 23 is a diagram illustrating an example of a table indicating recognition results in a variation of the present invention.

FIG. 24 is a block diagram illustrating an example of a hardware configuration of the information processing apparatus according to each of the example embodiments of the present invention.

### EXAMPLE EMBODIMENTS

### First Example Embodiment

The following description will discuss a first example embodiment of the present invention in detail with reference to the drawings. The present example embodiment is a basic form of example embodiments described later.

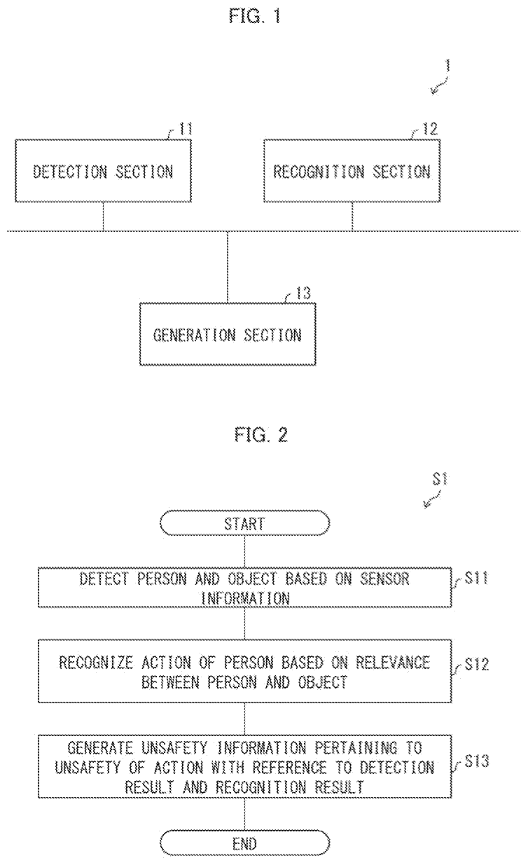

(Overview of information processing apparatus 1) The following description will discuss a configuration of an information processing apparatus 1 according to the present example embodiment, with reference to FIG. 1. FIG. 1 is a block diagram illustrating a configuration of the information processing apparatus 1 according to the present example embodiment.

The information processing apparatus 1 according to the present example embodiment detects a person and an object based on sensor information, and recognizes an action of the person based on a relevance between the person and the object which have been detected. Moreover, the information processing apparatus 1 generates unsafety information pertaining to unsafety of the action of the person with reference to the detection result and the recognition result.

The term “sensor information” refers to information output from one or more sensors. Examples of the “sensor information” include: an image output from a camera; information which is output from light detection and ranging (Lidar) and which indicates a distance to a target object; a distance image based on output from a depth sensor; a temperature image based on output from an infrared sensor; position information output using a beacon; a first-person viewpoint image of a wearer output from a wearable camera; and audio data output from a microphone array constituted by a plurality of microphones.

A method in which the information processing apparatus 1 detects a person and an object based on sensor information is not limited, and a known method is used. Examples of a method in which the information processing apparatus 1 detects a person and an object based on sensor information include: a method based on feature quantities of an image of histograms of oriented gradients (HOG), color histograms, a shape, or the like; a method based on local feature quantities around feature points (e.g., scale-invariant feature transform (SIFT)); and a method using a machine learning model (e.g., faster regions with convolutional neural networks (R-CNN)).

In order to measure a time period for which a person has continued an action, the information processing apparatus 1 detects, at a plurality of points in time or in a predetermined time period, a person and an object which are identical with a person and an object, respectively, detected at a certain point in time. In other words, the information processing apparatus 1 detects a person and an object which are identical with a person and an object, respectively, detected based on a certain piece of sensor information based on another piece of sensor information which has been obtained at a timing different from that of the certain piece of sensor information. A method of determining whether or not a person and an object which have been detected by the information processing apparatus 1 based on a certain piece of sensor information are respectively identical with a person and an object which have been detected based on another piece of sensor information output from the sensor at a timing different from that of the certain piece of sensor information is not limited, and a known method is used.

Examples of the method of determining whether or not a person and an object detected by the information processing apparatus 1 based on a certain piece of sensor information are respectively identical with a person and an object detected based on another piece of sensor information output from the sensor at a timing different from that of the certain piece of sensor information include: a method based on a degree of overlap between a circumscribed rectangle of a person (or object) detected based on a certain piece of sensor information and a circumscribed rectangle of a person (or object) detected based on another piece of sensor information obtained at a timing different from that of the certain piece of sensor information; a method based on a degree of similarity between a feature inside a circumscribed rectangle of a person (or object) detected based on a certain piece of sensor information and a feature inside a circumscribed rectangle of the person (or object) detected based on another piece of sensor information obtained at a timing different from that of the certain piece of sensor information; and a method using a machine learning model (e.g., DeepSort).

The term “relevance between a person and an object” refers to what relationship exists between the person and the object. Examples of the “relevance between a person and an object” include a fact that a certain person is related to a certain object, and a fact that a certain person is not related to a certain object.

Examples of a method in which the information processing apparatus 1 recognizes an action of a person based on a relevance between the person and an object include a method of recognizing that, in a case where a relevance between a person and an object indicates a fact that the person is related to the object, the person is carrying out an action using the object. Another example of a method in which the information processing apparatus 1 recognizes an action of a person based on a relevance between the person and an object is a method of recognizing that, in a case where a relevance between a person and an object indicates a fact that the person is not related to the object, the person is carrying out an action without using the object. Thus, the action which the information processing apparatus 1 recognizes can include an action using an object and an action without using an object.

The “unsafety information” is information pertaining to unsafety of an action of a person, and may include information that indicates a part of or all of a “fact that an action of a person is unsafe”, a “type of unsafe action”, and a “degree of unsafety”.

(Configuration of Information Processing Apparatus 1)

The following description will discuss a configuration of an information processing apparatus 1, with reference to FIG. 1. FIG. 1 is a block diagram illustrating a configuration of the information processing apparatus 1 according to the present example embodiment.

As illustrated in FIG. 1, the information processing apparatus 1 includes a detection section 11, a recognition section 12, and a generation section 13. The detection section 11, the recognition section 12, and the generation section 13 are configured to realize the detection means, the recognition means, and the generating means, respectively, in the present example embodiment.

The detection section 11 detects a person and an object based on sensor information. A method in which the detection section 11 detects a person and an object based on sensor information is as described above. The detection section 11 supplies, to the recognition section 12, information indicating the detected person and object.

The recognition section 12 recognizes, based on a relevance between the person and the object which have been detected by the detection section 11, an action of the person. A method in which the recognition section 12 recognizes an action of a person based on a relevance between the person and an object is as described above. The recognition section 12 supplies the recognition result to the generation section 13.

The generation section 13 generates unsafety information pertaining to unsafety of the action with reference to the detection result by the detection section 11 and the recognition result by the recognition section 12.

As described above, the information processing apparatus 1 according to the present example embodiment employs the configuration of including: the detection section 11 that detects a person and an object based on sensor information; the recognition section 12 that recognizes an action of the person based on a relevance between the person and the object; and the generation section 13 that generates unsafety information pertaining to unsafety of the action with reference to a detection result by the detection section 11 and a recognition result by the recognition section 12.

As such, according to the information processing apparatus 1 of the present example embodiment, unsafety information pertaining to unsafety of the recognized action of the person is generated. Therefore, it is possible to bring about an effect of improving safety of an action of a person.

(Flow of Information Processing Method S1)

The following description will discuss a flow of an information processing method S1 according to the present example embodiment with reference to FIG. 2. FIG. 2 is a flowchart illustrating the flow of the information processing method S1 according to the present example embodiment.

(Step S11)

In step S11, the detection section 11 detects a person and an object based on sensor information. The detection section 11 supplies, to the recognition section 12, information indicating the detected person and object.

(Step S12)

In step S12, the recognition section 12 recognizes, based on a relevance between the person and the object which have been detected by the detection section 11, an action of the person. The recognition section 12 supplies the recognition result to the generation section 13.

(Step S13)

In step S13, the generation section 13 generates unsafety information pertaining to unsafety of the action with reference to the detection result by the detection section 11 and the recognition result by the recognition section 12.

As described above, the information processing method 51 according to the present example embodiment employs the configuration of including: detecting, by the detection section 11, a person and an object based on sensor information; recognizing, by the recognition section 12, an action of the person based on a relevance between the person and the object detected by the detection section 11; and generating, by the generation section 13, unsafety information pertaining to unsafety of the action with reference to a detection result by the detection section 11 and a recognition result by the recognition section 12. Therefore, according to the information processing method S1 of the present example embodiment, an effect similar to that of the foregoing information processing apparatus 1 is brought about.

### Second Example Embodiment

The following description will discuss a second example embodiment of the present invention in detail with reference to the drawings. The same reference numerals are given to constituent elements which have functions identical with those described in the first example embodiment, and descriptions as to such constituent elements are omitted as appropriate.

(Overview of Information Processing System 100)

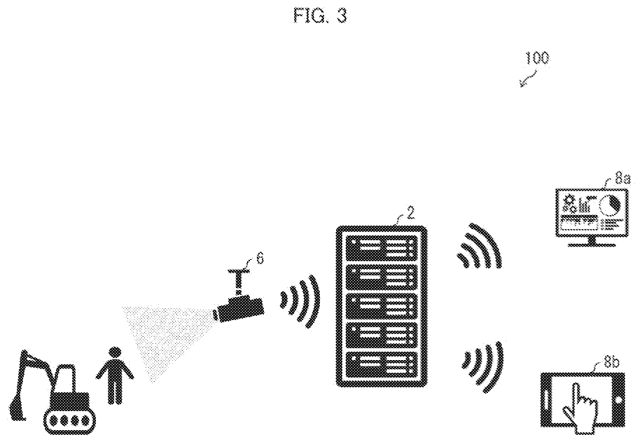

The following description will discuss an overview of an information processing system 100 according to the present example embodiment, with reference to FIG. 3. FIG. 3 is a schematic diagram illustrating the information processing system 100 according to the present example embodiment.

The information processing system 100 according to the present example embodiment detects a person and an object based on sensor information, and recognizes an action of the person based on a relevance between the person and the object which have been detected. Moreover, the information processing system 100 generates unsafety information pertaining to unsafety of the action of the person with reference to the detection result and the recognition result. Moreover, the information processing system 100 provides notification of the generated unsafety information.

For example, the information processing system 100 is configured to include an information processing apparatus 2, a camera 6, and a notification apparatus 8, as illustrated in FIG. 3. In the information processing system 100, the information processing apparatus 2 acquires, as sensor information, an image output from the camera 6 that has imaged a construction site where a person carries out an action using a backhoe or the like. Hereinafter, an action which a person carries out at a construction site is referred to also as an “operation”.

The information processing apparatus 2 detects a person and an object in the construction site based on the acquired image. The present example embodiment will discuss a case where a person is an operator, and an object is an operation object. The information processing apparatus 2 recognizes, based on a relevance between the detected operator and operation object, an operation which the operator is carrying out.

The information processing apparatus 2 generates unsafety information pertaining to unsafety of an action of a person with reference to the detection result and the recognition result. As described above, the “unsafety information” is information pertaining to unsafety of an action of a person, and may include information that indicates a part of or all of a “fact that an action of a person is unsafe”, a “type of unsafe action”, and a “degree of unsafety”. The information processing apparatus 2 outputs the generated unsafety information to the notification apparatus 8. The notification apparatus 8 provides notification of the acquired unsafety information.

Here, the notification apparatus 8 is an apparatus that provides notification of unsafety information. Examples of the notification apparatus 8 include a display apparatus 8a that displays an image, a tablet 8b, a speaker that outputs sounds, a lamp that emits light, and a vibrator that vibrates.

In the information processing system 100 illustrated in FIG. 3, for example, the information processing apparatus 2 outputs unsafety information to at least one of the display apparatus 8a and the tablet 8b. As another example, the information processing apparatus 2 may output an alert sound from a speaker which is worn by an operator who has carried out an unsafe action, or may output an alert from a speaker which is installed in a management office. The information processing apparatus 2 may turn on lamps which are installed in an operation site and a management office. The information processing apparatus 2 may cause the display apparatus 8a or the tablet 8b installed in a management office to play a video of an action which is recognized as an unsafe action.

(Configuration of Information Processing System 100)

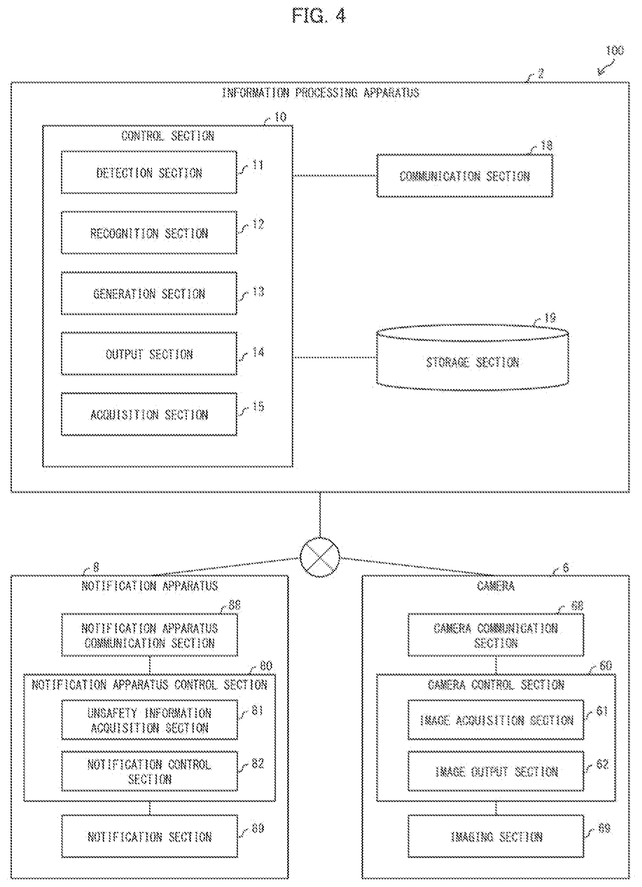

The following description will discuss a configuration of the information processing system 100 according to the present example embodiment, with reference to FIG. 4. FIG. 4 is a block diagram illustrating the configuration of the information processing system 100 according to the present example embodiment.

As illustrated in FIG. 4, the information processing system 100 is configured to include the information processing apparatus 2, the camera 6, and the notification apparatus 8. The information processing apparatus 2, the camera 6, and the notification apparatus 8 are communicably connected to each other via a network. A specific configuration of the network does not limited the present example embodiment but, as an example, it is possible to employ a wireless local area network (LAN), a wired LAN, a wide area network (WAN), a public network, a mobile data communication network, or a combination of these networks.

(Configuration of Information Processing Apparatus 2)

As illustrated in FIG. 4, the information processing apparatus 2 includes a control section 10, a communication section 18, and a storage section 19.

The communication section 18 is a communication module that communicates with other apparatuses that are connected via the network. For example, the communication section 18 outputs data supplied from the control section 10 to the display apparatus 8, and supplies data output from the camera 6 to the control section 10.

The storage section 19 stores data which the control section 10 refers to. For example, the storage section 19 stores sensor information, a recognition result, an unsafety condition (described later), and action identification information (described later).

(Function of Control Section 10)

The control section 10 controls constituent elements included in the information processing apparatus 2. As illustrated in FIG. 4, the control section 10 includes a detection section 11, a recognition section 12, a generation section 13, an output section 14, and an acquisition section The detection section 11, the recognition section 12, the generation section 13, the output section 14, and the acquisition section 15 are configured to realize the detection means, the recognition means, the generating means, the output means, and the acquisition means, respectively, in the present example embodiment.

The detection section 11 detects an operator and an operation object based on sensor information. For example, the detection section 11 detects one or more persons (operator) and one or more objects (operation object). A method in which the detection section 11 detects an operator and an operation object based on sensor information is as described above. The detection section 11 supplies, to the recognition section 12, information indicating the detected operator and operation object.

The recognition section 12 recognizes, based on a relevance between the operator and the operation object which have been detected by the detection section 11, an action of the operator. For example, the recognition section 12 recognizes, based on a relevance between a first person among the one or more operators detected by the detection section 11 and a first object among the one or more operation objects detected by the detection section 11, an operation of the first person.

Here, the “first person” refers to, among the persons detected by the detection section 11, a person who is related to an operation recognized by the recognition section 12. In the following description, a person different from the “first person” among the persons detected by the detection section 11 is referred to as a “second person”. In other words, the “second person” is a person who is not related to of the operation recognized by the recognition section 12.

The “first object” refers to an operation object which is related to an operation recognized by the recognition section 12 among the objects detected by the detection section 11. In other words, the “first object” is an object which has contributed to recognition of the action. In the following description, an object different from the “first object” among the objects detected by the detection section 11 is referred to as a “second object”. In other words, the “second object” is an object that is not related to the operation recognized by the recognition section 12.

For example, in an image including an operator pushing a handcart as a subject, the detection section 11 detects a plurality of persons including the operator pushing the handcart and a plurality of objects including the handcart. In this case, the recognition section 12 recognizes, based on the handcart and the operator pushing the handcart, that the operator is carrying out operation content “transportation”. Here, the operator pushing the handcart is referred to as a “first person”, a person other than the operator pushing the handcart is referred to as a “second person”, the handcart is referred to as a “first object”, and an object other than the handcart is referred to as a “second object”. The second object can include a handcart other than that handcart.

An example of a method in which the recognition section 12 recognizes an action of an operator based on a relevance between the operator and an operation object will be described later. The recognition section 12 causes the storage section 19 to store a recognition result.

The generation section 13 generates unsafety information pertaining to unsafety of the action with reference to the detection result by the detection section 11 and the recognition result by the recognition section 12. For example, in a case where the generation section 13 has determined, based on the detection result by the detection section 11, that an unsafety condition is satisfied, the generation section 13 generates unsafety information. Here, the unsafety condition is associated with an operation indicated by the recognition result by the recognition section 12 and is related to the second person or the second object. The generation section 13 supplies the generated unsafety information to the output section 14.

Here, the “detection result by the detection section 11” includes: a fact that a predetermined operator or a predetermined operation object has been detected; and a fact that a predetermined operator or a predetermined operation object has not been detected.

The “unsafety condition” is a condition which is determined according to the recognized operation. The “unsafety condition” is also defined as a condition that refers to a detection result related to a second person or a second object in an image. For example, an unsafety condition in the present example embodiment is stored in advance in the storage section 19. Specific examples of the unsafety condition will be described later. Examples of a process in which the generation section 13 generates unsafety information will also be described later.

The output section 14 outputs data. For example, the output section 14 outputs, via the communication section 18, unsafety information generated by the generation section 13 to the notification apparatus 8.

The acquisition section 15 acquires data supplied from the communication section 18. Examples of data acquired by the acquisition section 15 include an image output from the camera 6. The acquisition section 15 causes the storage section 19 to store the acquired data.

(Configuration of Camera 6)

As illustrated in FIG. 4, the camera 6 includes a camera control section 60, a camera communication section 68, and an imaging section 69.

The camera communication section 68 is a communication module that communicates with other apparatuses that are connected via the network. For example, the camera communication section 68 outputs data supplied from the camera control section 60 to the information processing apparatus 2.

The imaging section 69 is a device that images a subject included in an angle of view. For example, the imaging section 69 images a construction site where an operator and an operation object are included in the angle of view. The imaging section 69 supplies the captured image to the camera control section 60.

The camera control section 60 controls constituent elements included in the camera 6. As illustrated in FIG. 4, the camera control section 60 includes an image acquisition section 61 and an image output section 62.

The image acquisition section 61 acquires an image supplied from the imaging section 69. The image acquisition section 61 supplies the acquired image to the image output section 62.

The image output section 62 outputs data via the camera communication section 68. For example, the image output section 62 outputs an image supplied from the image acquisition section 61 to the information processing apparatus 2 via the camera communication section 68.

(Configuration of Notification Apparatus 8)

As illustrated in FIG. 4, the notification apparatus 8 includes a notification apparatus control section 80, a notification apparatus communication section 88, and a notification section 89.

The notification apparatus communication section 88 is a communication module that communicates with other apparatuses that are connected via the network. For example, the notification apparatus communication section 88 supplies, to the notification apparatus control section 80, unsafety information output from the information processing apparatus 2.

The notification section 89 provides notification of content indicated by the acquired information. A method of notification by the notification section 89 is not limited, and notification may be carried out by displaying an image, outputting a sound, vibrating, emitting light, or a combination of these.

The notification apparatus control section 80 controls constituent elements included in the notification apparatus 8. As illustrated in FIG. 4, the notification apparatus control section 80 includes an unsafety information acquisition section 81 and a notification control section 82.

The unsafety information acquisition section 81 acquires unsafety information supplied from the notification apparatus communication section 88. The unsafety information acquisition section 81 supplies the acquired unsafety information to the notification control section 82.

The notification control section 82 supplies, to the notification section 89, unsafety information supplied from the unsafety information acquisition section 81.

(Flow of Information Processing Method S2 Carried Out by Information Processing Apparatus 2)

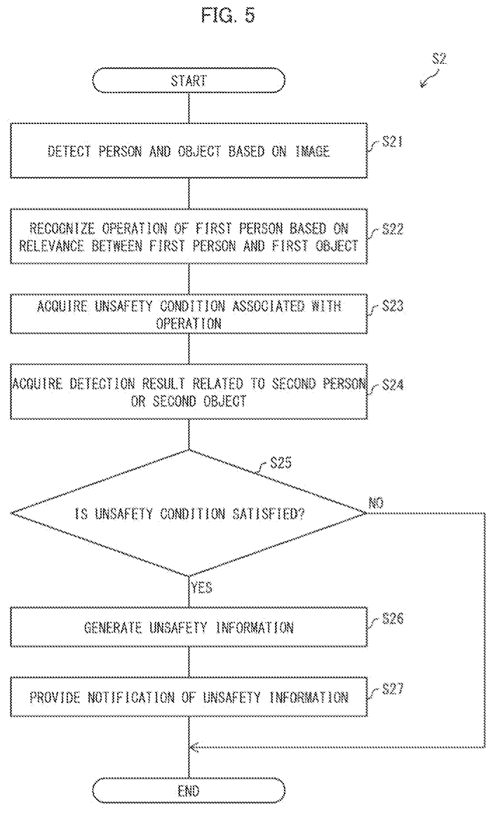

The following description will discuss a flow of an information processing method S2 carried out by the information processing apparatus 2 according to the present example embodiment, with reference to FIG. 5. FIG. 5 is a flowchart illustrating the flow of the information processing method S2 carried out by the information processing apparatus 2 according to the present example embodiment.

(Step S21)

In step S21, the detection section 11 detects one or more persons and one or more objects based on an image output from the camera 6. The detection section 11 supplies, to the recognition section 12, information indicating the detected one or more persons and one or more objects.

(Step S22)

In step S22, the recognition section 12 recognizes, based on a relevance between a first person among the one or more persons detected by the detection section 11 and a first object among the one or more objects detected by the detection section 11, an operation of the first person. The recognition section 12 supplies the recognition result to the generation section 13.

(Step S23)

In step S23, the generation section 13 acquires, from the storage section 19, an unsafety condition associated with an operation indicated by the recognition result by the recognition section 12.

(Step S24)

In step S24, the generation section 13 refers to the unsafety condition, and acquires a detection result related to a second person or a second object from the detection section 11.

(Step S25)

In step S25, the generation section 13 determines, based on the detection result, whether or not an unsafety condition is satisfied which is associated with the operation indicated by the recognition result and which is related to the second person or the second object.

(Step S26)

In a case where it has been determined in step S25 that the unsafety condition is satisfied (step S25: YES), the generation section 13 generates in step S26 unsafety information pertaining to unsafety of the operation indicated by the recognition result. The generation section 13 outputs the generated unsafety information to the output section 14.

(Step S27)

In step S27, the output section 14 outputs the unsafety information generated by the generation section 13 to the notification apparatus 8 via the communication section 18, and thus provides notification of the unsafety information.

After the end of step S27, or in step S25, in a case where it has been determined that the unsafety condition is not satisfied (step S25: NO), the information processing apparatus 2 terminates the process illustrated in FIG. 5.

### Example 1 of Method in which Recognition Section 12 Recognizes Action of Operator

Examples of a method in which the recognition section 12 recognizes an action of an operator include a method in which the recognition section 12 recognizes an action of an operator based on a position of the operator (position of a first person) and a position of an operation object (position of a first object).

For example, in a case where a distance between the position of the operator and the position of the operation object is equal to or less than a predetermined length, the recognition section 12 recognizes that the operator is carrying out an operation using the operation object. For example, in a case where a distance between a position of an operator and a position of a handcart is equal to or less than a predetermined length (e.g., 30 cm), the recognition section 12 recognizes that the operator is carrying out transportation, which is an operation using the handcart.

As another example, in a case where a position of an operator overlaps a position of an operation object, the recognition section 12 recognizes that the operator is carrying out an operation using the operation object. For example, in a case where a position of an operator overlaps a position of a backhoe, the recognition section 12 recognizes that the operator is carrying out excavation, which is an operation using the backhoe.

As described above, the recognition section 12 recognizes, based on the position of the operator and the position of the operation object, an action of the operator, and thus can accurately recognize the action by the operator using the operation object. Therefore, it is possible to recognize the action of the operator with higher accuracy.

### Example 2 of Method in which Recognition Section 12 Recognizes Action of Operator

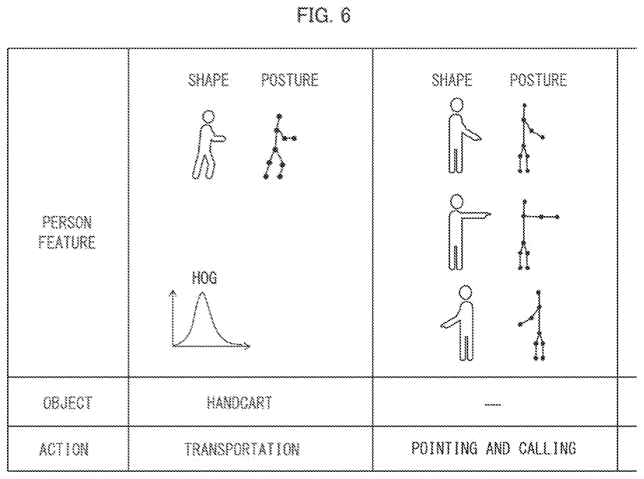

Another example of a method in which the recognition section 12 recognizes an action of an operator is a method in which the recognition section 12 refers to action identification information to recognize an action of an operator detected by the detection section 11. Here, the action identification information indicates a relevance between a feature of the operator (feature of a first person) in a predetermined action and a feature of an operation object (feature of a first object) related to the predetermined action. The following description will discuss action identification information with reference to FIG. 6. FIG. 6 is a diagram illustrating an example of action identification information according to the present example embodiment.

As illustrated in FIG. 6, the action identification information indicates a relevance between a person feature (a shape of a person, a posture of a person, and HOG in FIG. 6) in a predetermined action (“transportation” and “pointing and calling” in FIG. 6) and a feature of an object (“handcart” in FIG. 6) related to the predetermined action. The recognition section 12 determines whether or not a person feature of an operator and a feature of an operation object detected by the detection section 11 are identical with a person feature and a feature of an object in the action identification information.

In the action identification information, a plurality of “person features” may be associated with a predetermined action. For example, as illustrated in FIG. 6, in the action identification information, a shape of a person, a posture of a person, and HOG as the “person feature” may be associated with a predetermined action “transportation”.

As illustrated in FIG. 6, the action identification information may include a plurality of shapes of persons, a plurality of postures of persons, and a plurality of HOG in the “person feature”. For example, as illustrated in FIG. 6, in the action identification information, the predetermined action “pointing and calling” may be associated with, as the “person feature”, a shape of a person pointing downward on the right, a shape of a person pointing at a different angle (i.e., a shape of a person pointing in the horizontal direction on the right), and a shape of a person pointing in a different direction (i.e., a shape of a person pointing downward on the left).

Examples of the person feature in action identification information include a color and a local feature quantity, in addition to a shape of a person, a posture of a person, and HOG.

In a case where the person feature of the operator and the feature of the operation object detected by the detection section 11 are identical with the person feature and the feature of the object in the action identification information, the recognition section 12 recognizes that an action associated with the person feature and the feature of the object in the action identification information is an operation which the operator is carrying out.

Meanwhile, in a case where the person feature of the operator and the feature of the operation object detected by the detection section 11 are not identical with the person feature and the feature of the object in the action identification information, the recognition section 12 recognizes that an operation of the operator is an unidentified action, which indicates that the operation could not be identified. In other words, in a case where an action of the operator is not any of a plurality of predetermined actions, the recognition section 12 recognizes that the action of the operator is an unidentified action.

As illustrated in FIG. 6, the action identification information includes: an action (such as the action “transportation”) which is associated with an object “handcart”; and an action (such as the action “pointing and calling”) which is not associated with an object. In other words, an action which the recognition section 12 recognizes includes an action using an object and an action without using an object.

As described above, the recognition section 12 refers to action identification information that indicates a relevance between a feature of an operator in a predetermined action and a feature of an operation object related to the predetermined action, and recognizes an action of the operator detected by the detection section 11. Thus, the recognition section 12 can recognize an action of the operator with higher accuracy.

Moreover, with this configuration, the recognition section 12 can recognize, with higher accuracy, an action of an operator even in a case where the operator carries out an action without using an object.

### Example 3 of Method in which Recognition Section 12 Recognizes Action of Operator

As yet another example of a method in which the recognition section 12 recognizes an action of an operator, there is a method of recognizing an action of an operator based on, in addition to the operator (first person) and an operation object (first object), an environment surrounding the operator or the operation object.

For example, in a case where the recognition section 12 has recognized that concrete exists in addition to an operator and an operation object as an environment surrounding the operator or the operation object, the recognition section 12 recognizes that the operator is carrying out an operation of “leveling concrete”.

As described above, the recognition section 12 recognizes an action of an operator based on, in addition to an operator and an operation object, an environment surrounding the operator or the operation object. Thus, the recognition section 12 can recognize, with higher accuracy, an action of the operator.

### Example 4 of Method in which Recognition Section 12 Recognizes Action of Operator

As a still another example of a method in which the recognition section 12 recognizes an action of an operator, in a case where operation objects (first objects) which have been detected by the detection section 11 based on pieces of sensor information respectively acquired from a plurality of sensors vary depending on the pieces of sensor information, the recognition section 12 may recognize an action of an operator based on an operation object determined based on a majority decision.

For example, in a case where an operation object which has been detected based on sensor information output from a sensor 1 is an object 1, an operation object which has been detected based on sensor information output from a sensor 2 is an object 2, and an operation object which has been detected based on sensor information output from a sensor 3 is the object 1, the recognition section 12 recognizes, based on the object 1, an action of the operator.

Thus, in a case where the detection section 11 has acquired pieces of sensor information respectively from the plurality of sensors, the recognition section 12 recognizes an action of an operator based on an operation object determined based on a majority decision. Therefore, it is possible to reduce erroneous recognition.

### Example of Unsafety Condition

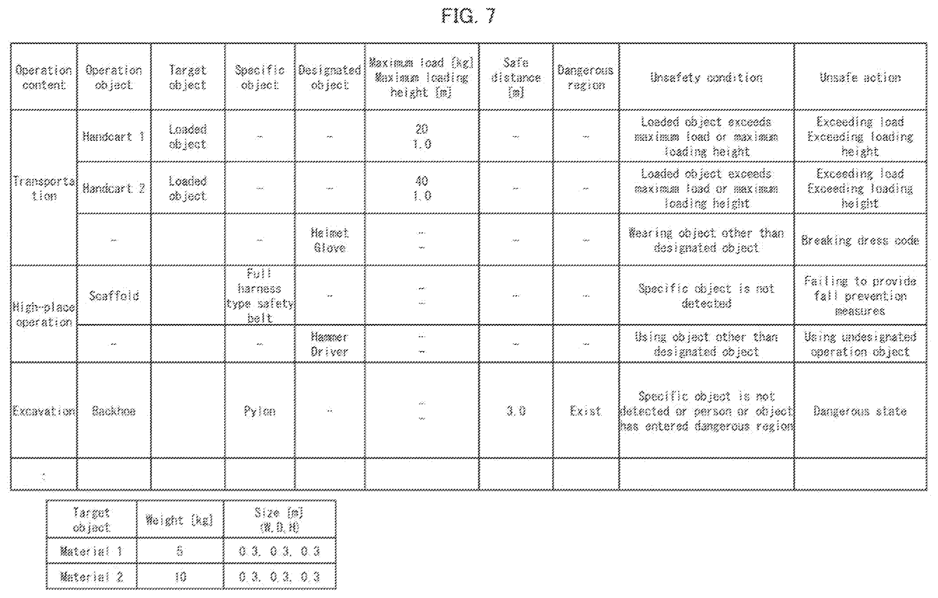

The following description will discuss an example of an unsafety condition with reference to FIG. 7. FIG. 7 is an example of an unsafety condition which is referred to by the generation section 13 according to the present example embodiment. As illustrated in FIG. 7, a plurality of items are associated with the “unsafety condition”.

“Operation content” in the upper table of FIG. 7 indicates an operation which has been recognized by the recognition section 12.

An “operation object” in the upper table of FIG. 7 indicates an object which is related to an operation recognized by the recognition section 12, and is a first object.

A “target object” in the upper table of FIG. 7 indicates an object to be subjected to an operation, and is an example of a second object.

A “specific object” in the upper table of FIG. 7 indicates an object necessary for safety of an operation, and is an example of a second object.

A “designated object” in the upper table of FIG. 7 indicates an object (so-called white list) which is not determined to be unsafe. An object which is not included in the “designated object” is a second object that is not associated with an operation.

A “maximum load” and a “maximum loading height” in the upper table of FIG. 7 respectively indicate a maximum weight and a maximum height at which a target object can be loaded.

A “safe distance” in the upper table of FIG. 7 indicates a distance in which it is not determined to be unsafe. In other words, the “safe distance” indicates a range (dangerous region) which is determined to be unsafe.

A “dangerous region” in the upper table of FIG. 7 indicates the presence or absence of a dangerous region.

An “unsafety condition” in the upper table of FIG. 7 indicates a condition under which it is determined to be unsafe.

The “unsafe action” in the upper table of FIG. 7 indicates a type of unsafe action in a case where the “unsafety condition” is satisfied.

In the foregoing step S23, the generation section 13 acquires, from the upper table of FIG. 7, an “unsafety condition” which is associated with “operation content” and an “operation object” which are respectively identical with an operation and an operation object indicated by the recognition result by the recognition section 12. Next, in the foregoing step S24, the generation section 13 acquires a detection result related to a “second person” or a “second object” based on the acquired “unsafety condition”. Then, in step S25, the generation section 13 refers to the “unsafety condition”, the “maximum load and maximum loading height”, the “safe distance”, and the “dangerous region” in the upper table of FIG. 7, and determines whether or not the unsafety condition is satisfied. In a case where it has been determined in step S25 that the unsafety condition is satisfied, the generation section 13 generates, in step S26, unsafety information indicating the “unsafe action” in the upper table of FIG. 7.

The following description will discuss, with reference to a specific example, a process in which the generation section 13 generates unsafety information. In the following description, a configuration will be described in which the generation section 13 generates unsafety information including information indicating a type of unsafe action.

(Process 1 in which Generation Section 13 Generates Unsafety Information)

The following description will discuss an example of a process in which the generation section 13 generates unsafety information, with reference to FIG. 8. FIG. 8 is a diagram illustrating an example of an image captured in the present example embodiment.

It is possible that: the second object is an object to be subjected to the operation; the generation section 13 extracts a feature of the second object based on a detection result; and in a case where an unsafety condition related to the feature of the second object is satisfied, the generation section 13 generates unsafety information.

For example, upon acquisition of an image illustrated in FIG. 8, the detection section 11 detects an “operator 1”, a “handcart 1”, and “materials 1 (two pieces (horizontal)×four pieces (vertical)=eight pieces in total)” in the foregoing step S21. The detection section 11 supplies the detection result to the recognition section 12.

In the foregoing step S22, the recognition section 12 refers to the detection result, and recognizes operation content “transportation” of the “operator 1” based on a relevance between the “operator 1” and the “handcart 1”. The recognition section 12 supplies the recognition result to the generation section 13.

In the foregoing step S23, the generation section 13 refers to the upper table of FIG. 7, and acquires an unsafety condition “loaded object exceeds maximum load or maximum loading height” which is associated with the operation content “transportation” and the operation object “handcart 1” indicated in the recognition result.

Next, in the foregoing step S24, the generation section 13 acquires a detection result related to the target object “loaded object” which is a second object included in the unsafety condition and which is to be subjected to the operation. The detection result by the detection section 11 is the “operator 1” (first person), the “handcart 1” (first object), and the “materials 1 (two pieces (horizontal) x four pieces (vertical)=eight pieces in total)”. Therefore, the generation section 13 acquires the “materials 1 (two pieces (horizontal)×four pieces (vertical)=eight pieces in total)” as the second object.

Subsequently, in the foregoing step S25, the generation section 13 refers to the lower table of FIG. 7, and acquires a weight (5 kg×eight pieces=40 kg) and a size (width of 0.3×2=0.6 m, height of 0.3×8=2.4 m), which are features of the second object “materials 1 (two pieces (horizontal) x four pieces (vertical)=eight pieces in total)”.

The generation section 13 further determines whether or not the unsafety condition acquired in step S23 is satisfied. As shown in the upper part of FIG. 7, the maximum loading capacity of the handcart 1 is “20 kg” and the maximum loading height of the handcart 1 is “1.0 m”, and the second object “materials 1 (two pieces (horizontal) x four pieces (vertical)=eight pieces in total)” has the weight of 40 kg and the height of 2.4 m. Therefore, the generation section 13 determines that the unsafety condition “loaded object exceeds maximum load or maximum loading height” is satisfied.

Then, in the foregoing step S26, the generation section 13 generates unsafety information indicating unsafe actions “exceeding load” and “exceeding loading height” in the upper table of FIG. 7.

As described above, the second object is an object to be subjected to the operation; the generation section 13 extracts a feature of the second object based on the detection result; and in a case where an unsafety condition related to the feature of the second object is satisfied, the generation section 13 generates unsafety information. As such, the generation section 13 generates unsafety information indicating that an operation is unsafe due to an object to be subjected to the operation. Therefore, it is possible to improve safety of an action of a person.

(Process 2 in which Generation Section 13 Generates Unsafety Information)

The following description will discuss another example of a process in which the generation section 13 generates unsafety information, with reference to FIG. 9. FIG. 9 is a diagram illustrating another example of an image captured in the present example embodiment.

It is possible that: the second object is an object that is necessary for safety of an operation; and in a case where an unsafety condition that the second object has not been detected is satisfied, the generation section 13 generates unsafety information based on the detection result.

For example, upon acquisition of an image illustrated in FIG. 9, the detection section 11 detects an “operator 1” and a “scaffold” in the foregoing step S21. The detection section 11 supplies the detection result to the recognition section 12.

In the foregoing step S22, the recognition section 12 refers to the detection result, and recognizes operation content “high-place operation” of the “operator 1” based on a relevance between the “operator 1” and the “scaffold”. The recognition section 12 supplies the recognition result to the generation section 13.

In the foregoing step S23, the generation section 13 refers to the upper table of FIG. 7, and acquires an unsafety condition “specific object is not detected” which is associated with the operation content “high-place operation” and the operation object “scaffold” indicated in the recognition result.

Next, in the foregoing step S24, the generation section 13 acquires a detection result related to a specific object “full harness type safety belt” which is necessary for safety of the operation and which is a second object included in the unsafety condition.

Subsequently, in the foregoing step S25, the generation section 13 determines whether or not the unsafety condition acquired in step S23 is satisfied. The detection result does not include the “full harness type safety belt”. Therefore, the generation section 13 determines that the unsafety condition “specific object is not detected” is satisfied.

Then, in the foregoing step S26, the generation section 13 generates unsafety information indicating an unsafe action “failing to provide fall prevention measures” in the upper table of FIG. 7.

As described above, the second object is an object that is necessary for safety of the operation; and in a case where the unsafety condition that the second object has not been detected is satisfied, the generation section 13 generates unsafety information based on the detection result. As such, the generation section 13 generates unsafety information indicating that an operation is unsafe due to the absence of an object necessary for safety of the operation. Therefore, it is possible to improve safety of an action of a person.

(Process 3 in which Generation Section 13 Generates Unsafety Information)

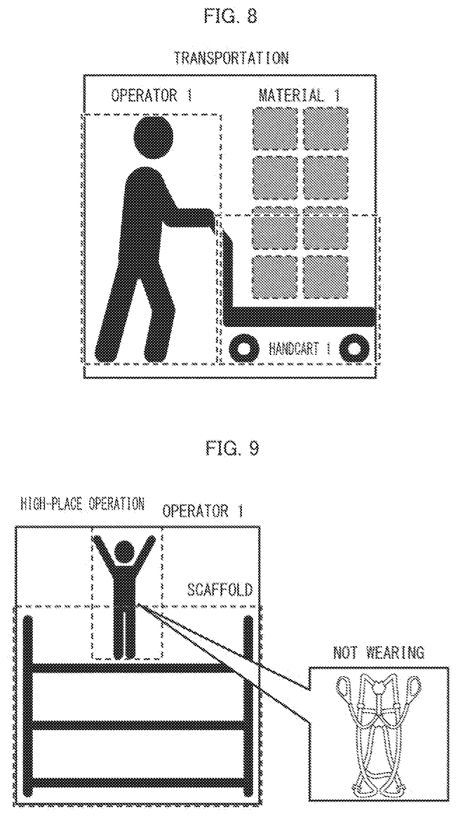

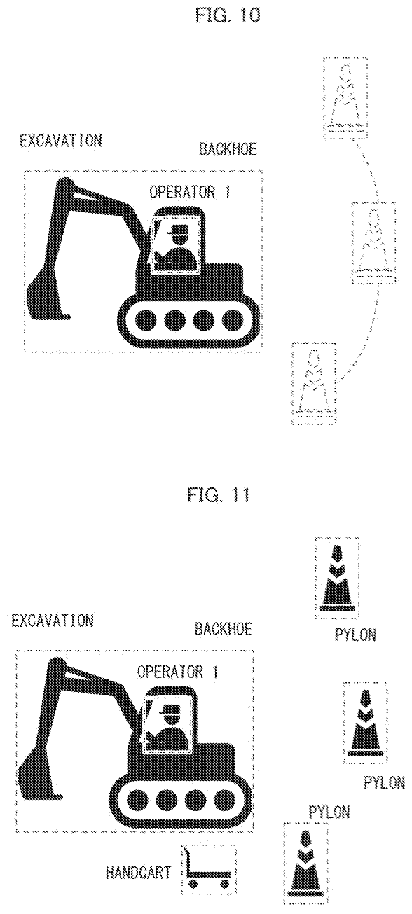

The following description will discuss, with reference to FIG. 10, another example configuration in which: the second object is an object that is necessary for safety of an operation; and in a case where an unsafety condition that the second object has not been detected is satisfied, the generation section 13 generates unsafety information based on the detection result. FIG. 10 is a diagram illustrating still another example of an image captured in the present example embodiment.

Upon acquisition of an image illustrated in FIG. 10, the detection section 11 detects an “operator 1” and a “backhoe” in the foregoing step S21. The detection section 11 supplies the detection result to the recognition section 12.

In the foregoing step S22, the recognition section 12 refers to the detection result, and recognizes operation content “excavation” of the “operator 1” based on a relevance between the “operator 1” and the “backhoe”. The recognition section 12 supplies the recognition result to the generation section 13.

In the foregoing step S23, the generation section 13 refers to the upper table of FIG. 7, and acquires an unsafety condition “specific object is not detected” which is associated with the operation content “excavation” and the operation object “backhoe” indicated in the recognition result. An unsafety condition “person or object has entered dangerous region” will be described later with reference to a different drawing.

Next, in the foregoing step S24, the generation section 13 acquires a detection result related to a specific object “pylon” which is necessary for safety of the operation and which is a second object included in the unsafety condition “specific object is not detected”.

Subsequently, in the foregoing step S25, the generation section 13 determines whether or not the unsafety condition acquired in step S23 is satisfied. The detection result does not include the “pylon”. Therefore, the generation section 13 determines that the unsafety condition “specific object is not detected” is satisfied.

Then, in the foregoing step S26, the generation section 13 generates unsafety information indicating an unsafe action “dangerous state” in the upper table of FIG. 7.

(Process 4 in which Generation Section 13 Generates Unsafety Information)

The following description will discuss still another example of a process in which the generation section 13 generates unsafety information, with reference to FIG. 11. FIG. 11 is a diagram illustrating still another example of an image captured in the present example embodiment.

It is possible that: the second object is an object that is not associated with an operation; and in a case where an unsafety condition that the second object has been detected is satisfied, the generation section 13 generates unsafety information based on the detection result.

For example, upon acquisition of an image illustrated in FIG. 11, the detection section 11 detects an “operator 1”, a “backhoe”, a “handcart” and “pylons (three pieces)” in the foregoing step S21. The detection section 11 supplies the detection result to the recognition section 12.

In the foregoing step S22, the recognition section 12 refers to the detection result, and recognizes operation content “excavation” of the “operator 1” based on a relevance between the “operator 1” and the “backhoe”. The recognition section 12 supplies the recognition result to the generation section 13.

In the foregoing step S23, the generation section 13 refers to the upper table of FIG. 7, and acquires an unsafety condition “object has entered dangerous region” which is associated with the operation content “excavation” and the operation object “backhoe” indicated in the recognition result. An unsafety condition “person has entered dangerous region” will be described later with reference to a different drawing.

Next, in the foregoing step S24, the generation section 13 acquires a detection result related to an object (second object) which is included in the unsafety condition “object has entered dangerous region”.

Subsequently, in the foregoing step S25, the generation section 13 determines whether or not the unsafety condition acquired in step S23 is satisfied. The detection result includes the second object “handcart” which is not associated with the operation “excavation”. Therefore, the generation section 13 determines that the unsafety condition “object has entered dangerous region” is satisfied.

Then, in the foregoing step S26, the generation section 13 generates unsafety information indicating an unsafe action “dangerous state” in the upper table of FIG. 7.

As described above, the second object is an object that is not associated with an operation; and in a case where the unsafety condition that the second object has been detected is satisfied, the generation section 13 generates unsafety information based on the detection result. As such, the generation section 13 generates unsafety information indicating that an operation is unsafe due to an object which is not related to the operation. Therefore, it is possible to improve safety of an action of a person.

(Process 5 in which Generation Section 13 Generates Unsafety Information)

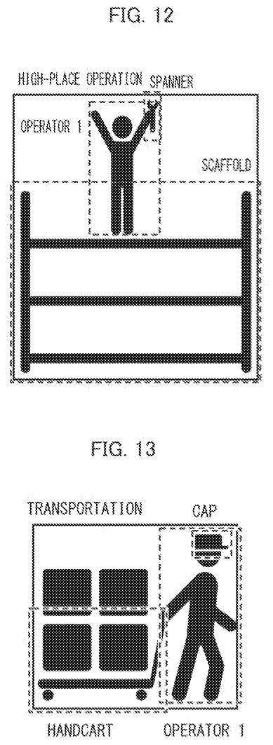

The following description will discuss still another example of a process in which the generation section 13 generates unsafety information, with reference to FIG. 12. FIG. 12 is a diagram illustrating still another example of an image captured in the present example embodiment.

It is possible that: the second object is an object that is not associated with an operation; and in a case where an unsafety condition that the second person is using or wearing the second object is satisfied, the generation section 13 generates unsafety information based on the detection result.

For example, upon acquisition of an image illustrated in FIG. 12, the detection section 11 detects an “operator 1”, a “scaffold”, and a “spanner” in the foregoing step S21. The detection section 11 supplies the detection result to the recognition section 12.

In the foregoing step S22, the recognition section 12 refers to the detection result, and recognizes operation content “high-place operation” of the “operator 1” based on a relevance between the “operator 1” and the “scaffold”. The recognition section 12 supplies the recognition result to the generation section 13.

In the foregoing step S23, the generation section 13 refers to the upper table of FIG. 7, and acquires an unsafety condition “using object other than designated object” which is associated with operation content “high-place operation” indicated in the recognition result.

Next, in the foregoing step S24, the generation section 13 acquires a detection result related to an object other than designated objects “hammer” and “driver” which are second objects included in the unsafety condition.

Subsequently, in the foregoing step S25, the generation section 13 determines whether or not the unsafety condition acquired in step S23 is satisfied. The detection result includes a “spanner” which is an object other than the designated objects “hammer” and “driver”. Therefore, the generation section 13 determines that the unsafety condition “using object other than designated object” is satisfied.

In the foregoing step S26, the generation section 13 generates unsafety information indicating an unsafe action “using undesignated operation object” in the upper table of FIG. 7.

As described above, the second object is an object that is not associated with an operation; and in a case where the unsafety condition that the second person is using or wearing the second object is satisfied, the generation section 13 generates unsafety information based on the detection result. As such, the generation section 13 generates unsafety information indicating that an operation is unsafe due to the presence of an object unnecessary for safety of the operation. Therefore, it is possible to improve safety of an action of a person.

(Process 6 in which Generation Section 13 Generates Unsafety Information)

The following description will discuss, with reference to FIG. 13, another example of the configuration in which: the second object is an object that is not associated with an operation; and in a case where an unsafety condition that the second person is using or wearing the second object is satisfied, the generation section 13 generates unsafety information based on the detection result. FIG. 13 is a diagram illustrating still another example of an image captured in the present example embodiment.

Upon acquisition of an image illustrated in FIG. 13, the detection section 11 detects an “operator 1”, a “handcart” and a “cap” in the foregoing step S21. The detection section 11 supplies the detection result to the recognition section 12.

In the foregoing step S22, the recognition section 12 refers to the detection result, and recognizes operation content “transportation” of the “operator 1” based on a relevance between the “operator 1” and the “handcart”. The recognition section 12 supplies the recognition result to the generation section 13.

In the foregoing step S23, the generation section 13 refers to the upper table of FIG. 7, and acquires an unsafety condition “wearing object other than designated object” which is associated with operation content “transportation” indicated in the recognition result.

Next, in the foregoing step S24, the generation section 13 acquires a detection result related to designated objects “helmet” and “glove” which are second objects included in the unsafety condition “wearing object other than designated object” and which do not lead to determination of being unsafe.

Subsequently, in the foregoing step S25, the generation section 13 determines whether or not the unsafety condition acquired in step S23 is satisfied. The detection result includes a “cap” other than the designated objects “helmet” and “glove”. Therefore, the generation section 13 determines that the unsafety condition “wearing object other than designated object” is satisfied.

Then, in the foregoing step S26, the generation section 13 generates unsafety information indicating an unsafe action “breaking dress code” in the upper table of FIG. 7.

(Process 7 in which generation section 13 generates unsafety information)

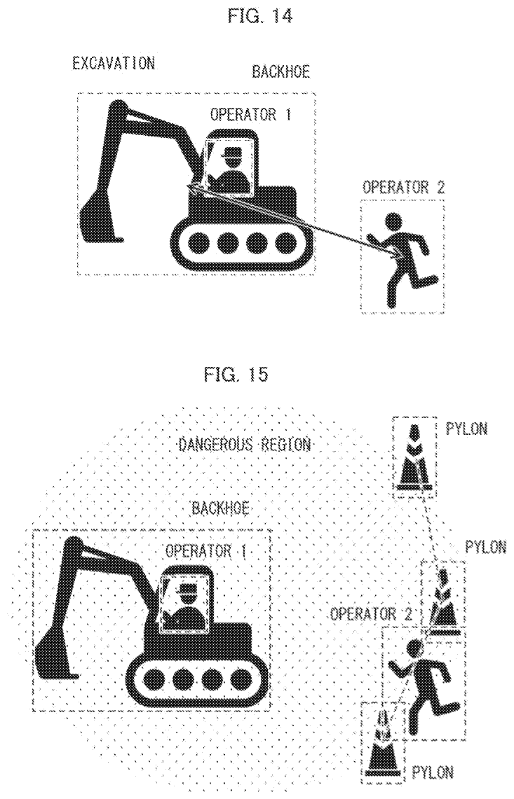

The following description will discuss still another example of a process in which the generation section 13 generates unsafety information, with reference to FIG. 14. FIG. 14 is a diagram illustrating still another example of an image captured in the present example embodiment.

In a case where an unsafety condition that a second person has been detected in a predetermined range from the first object is satisfied, the generation section 13 may generate unsafety information based on the detection result.

For example, upon acquisition of an image illustrated in FIG. 14, the detection section 11 detects an “operator 1”, a “backhoe” and an “operator 2” in the foregoing step S21. The detection section 11 supplies the detection result to the recognition section 12.

In the foregoing step S22, the recognition section 12 refers to the detection result, and recognizes operation content “excavation” of the “operator 1” based on a relevance between the “operator 1” and the “backhoe”. The recognition section 12 supplies the recognition result to the generation section 13.

In the foregoing step S23, the generation section 13 refers to the upper table of FIG. 7, and acquires an unsafety condition “person has entered dangerous region” which is associated with the operation content “excavation” and the operation object “backhoe” indicated in the recognition result.

Next, in the foregoing step S24, the generation section 13 acquires a detection result related to a second person who is included in the unsafety condition “person has entered dangerous region”.

Subsequently, in the foregoing step S25, the generation section 13 determines whether or not the unsafety condition acquired in step S23 is satisfied. First, the detection result includes an “operator 2” who is a second person. Moreover, the dangerous region “exists” and the safe distance is “3.0 m”. Therefore, the generation section 13 sets a range defined by the safe distance “3.0 m” from the operation object “backhoe” as a dangerous region, and determines whether or not the second person “operator 2” has been detected in the dangerous region. Here, an example of the range defined by the safe distance “3.0 m” from the operation object “backhoe” is a “3.0 m” range from the center of a circumscribed rectangle of the operation object “backhoe”.

In a case where it has been determined that the “operator 2” who is the second person is detected in the dangerous region, the generation section 13 determines that the unsafety condition “person has entered dangerous region” is satisfied.

Then, in the foregoing step S26, the generation section 13 generates unsafety information indicating an unsafe action “dangerous state” in the upper table of FIG. 7.

As described above, in a case where the unsafety condition that the second person has been detected in the predetermined range from the first object is satisfied, the generation section 13 generates unsafety information based on the detection result. As such, the generation section 13 generates unsafety information indicating that a person who is not related to the operation has entered the dangerous region. Therefore, it is possible to improve safety of an action of a person.

(Process 8 in which Generation Section 13 Generates Unsafety Information)

The following description will discuss, with reference to FIG. 15, another example of the configuration in which, in a case where an unsafety condition that a second person has been detected in a predetermined range from the first object is satisfied, the generation section 13 generates unsafety information based on the detection result. FIG. 15 is a diagram illustrating still another example of an image captured in the present example embodiment.

Upon acquisition of an image illustrated in FIG. 15, the detection section 11 detects an “operator 1”, an “operator 2”, a “backhoe”, and “pylons (three pieces)” in the foregoing step S21. The detection section 11 supplies the detection result to the recognition section 12.

In the foregoing step S22, the recognition section 12 refers to the detection result, and recognizes operation content “excavation” of the “operator 1” based on a relevance between the “operator 1” and the “backhoe”. The recognition section 12 supplies the recognition result to the generation section 13.

In the foregoing step S23, the generation section 13 refers to the upper table of FIG. 7, and acquires an unsafety condition “person has entered dangerous region” which is associated with the operation content “excavation” and the operation object “backhoe” indicated in the recognition result.

Next, in the foregoing step S24, the generation section 13 acquires a detection result related to a second person who is included in the unsafety condition “person has entered dangerous region”.

Subsequently, in the foregoing step S25, the generation section 13 determines whether or not the unsafety condition acquired in step S23 is satisfied. First, the detection result includes an “operator 2” who is a second person. In addition, the dangerous region “exists” and the designated objects are pieces of “pylon”. Therefore, the generation section 13 sets, to a dangerous region, a region between (i) lines connecting the plurality of specific objects “pylons” which are the second objects and (ii) the operation object “backhoe”. Then, the generation section 13 determines whether or not the second person “operator 2” has been detected in the dangerous region. Examples of the lines connecting the plurality of specific objects “pylons” include a line connecting centers of circumscribed rectangles of the respective “pylons”.

In a case where it has been determined that the “operator 2” which is a second person is detected in the dangerous region, the generation section 13 determines that the unsafety condition “person has entered dangerous region” is satisfied.

Then, in the foregoing step S26, the generation section 13 generates unsafety information indicating an unsafe action “dangerous state” in the upper table of FIG. 7.

Note that the “dangerous region” may be set by a user. For example, 3 m areas respectively surrounding the plurality of specific objects “pylons” may each be set to a “dangerous region”. With this configuration, the generation section 13 generates unsafety information indicating that there is a person who is approaching or trying to enter a region between the pylon and the backhoe. Therefore, it is possible to improve safety of an action of a person.

As such, in a case where the unsafety condition that the second person is approaching or has entered a dangerous region which is specified by the second object is satisfied, the generation section 13 generates unsafety information based on the detection result. Thus, the generation section 13 generates unsafety information indicating that a person who is not related to the operation has entered or is trying to enter a dangerous region. Therefore, it is possible to improve safety of an action of a person.

### Example 1 of Unsafety Information Output by Output Section 14

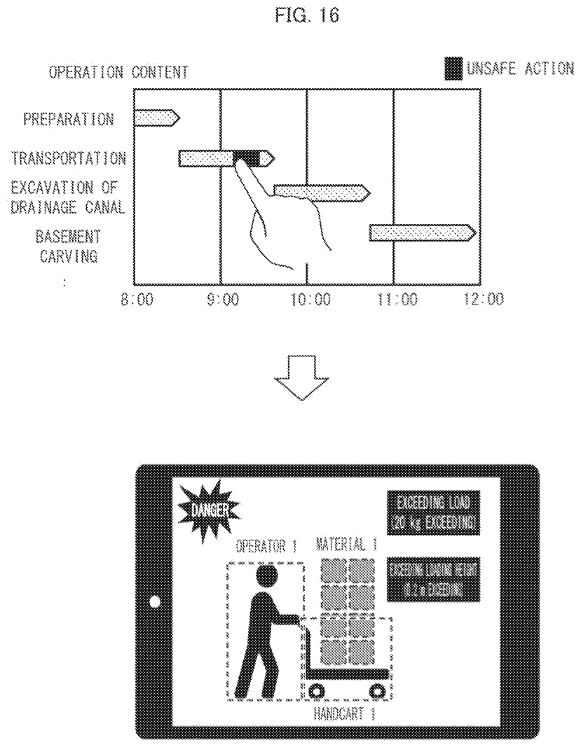

The following description will discuss an example of unsafety information output by the output section 14, with reference to FIG. 16. FIG. 16 is a diagram illustrating an example of unsafety information which is output by the output section 14 according to the present example embodiment. The following description will discuss a case where the output section 14 outputs an image as unsafety information.

As illustrated in the upper part of FIG. 16, the output section 14 may output an image in which the operation content in which and a time at which an unsafe action was carried out are included in a Gantt chart indicating a relation between the operation content and the time. The diagram illustrated in the upper part of FIG. 16 indicates that an unsafe action was carried out in operation content “transportation” during a time period between “9:10” and “9:30”.

It is possible that, in a case where information has been acquired which indicates that a user operation on a period during which the unsafe action was carried out has been received with respect to the image output by the output section 14, the output section 14 outputs an image indicating the operation determined to involve the unsafe action, as illustrated in the lower part of FIG. 16.

In this case, as illustrated in the lower part of FIG. 16, the output section 14 may include, in the image, text indicating unsafe actions “exceeding load” and “exceeding loading height”, and text indicating an excess weight “20 kg exceeding” and an excess height “0.2 m exceeding”.

The output section 14 may output, as a video, all images that are in a period during which an operation determined to involve an unsafe action was carried out and that indicate the operation. Alternatively, the output section 14 may output images at predetermined intervals. Alternatively, the output section 14 may output one or more images extracted as a key frame.

As illustrated in the lower part of FIG. 16, the output section 14 may output circumscribed rectangles of the detected person (operator 1) and the detected objects (handcart 1 and material 1) while superimposing the circumscribed rectangles on an image. The output section 14 may output an object name of the detected object or an object ID for distinguishing from another object while superimposing the object name or object ID on an image.

### Example 2 of Unsafety Information Output by Output Section 14

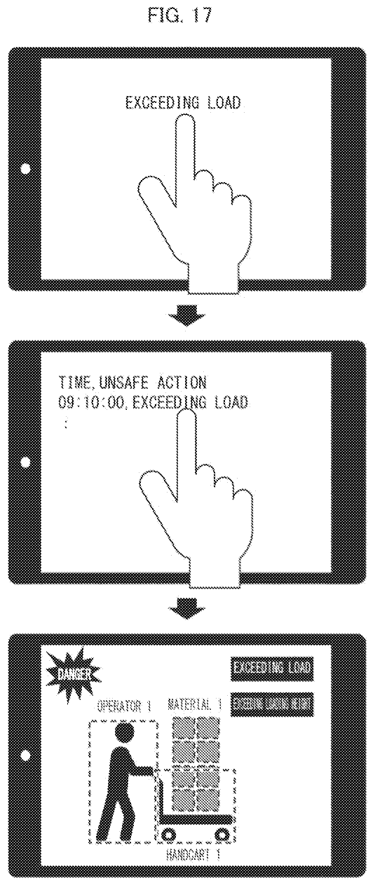

The following description will discuss another example of unsafety information output by the output section 14, with reference to FIG. 17. FIG. 17 is a diagram illustrating another example of unsafety information which is output by the output section 14 according to the present example embodiment. The following description will also discuss a case where the output section 14 outputs an image as unsafety information.

In a case where the output section 14 outputs an image in which unsafe actions that occurred in the past are listed and has received an operation to select any of the unsafe actions included in the image, the output section 14 may output a list including a time at which the selected unsafe action occurred.

For example, as illustrated in the upper part of FIG. 17, the output section 14 outputs an image in which unsafe actions that occurred in the past are listed. Next, upon receipt of a user operation to select an unsafe action “exceeding load”, the output section 14 outputs an image in which times at which the unsafe actions “exceeding load” occurred are listed, as illustrated in the middle of FIG. 17.

In addition, in a case where the output section 14 has received an operation to select one of the unsafe actions which are included in the image of the list of times at which the selected unsafe action occurred, the output section 14 may output an image of an operation determined to involve the selected unsafe action.

For example, as illustrated in the middle of FIG. 17, the output section 14 receives a user operation to select an unsafe action “exceeding load” which occurred at a time “9:10:00”. Then, as illustrated in the lower part of FIG. 17, the output section 14 outputs an image of an operation determined to involve the unsafe action “exceeding load” carried out at “9:10:00”.

(Example 3 of Unsafety Information Output by Output Section 14)

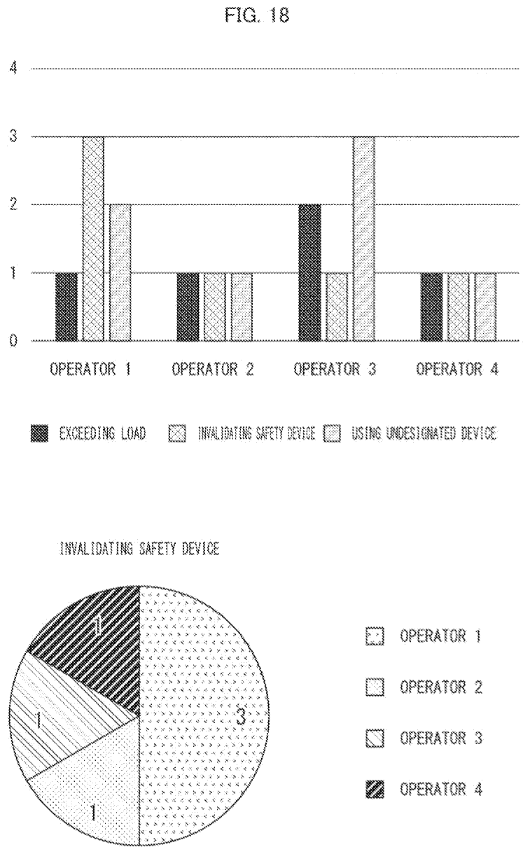

The following description will discuss another example of unsafety information output by the output section 14, with reference to FIG. 18. FIG. 18 is a diagram illustrating still another example of unsafety information which is output by the output section 14 according to the present example embodiment. The following description will also discuss a case where the output section 14 outputs an image as unsafety information.

The output section 14 may output a graph indicating a type of unsafe action and the number of occurrences of the unsafe action.

For example, as illustrated in the upper part of FIG. 18, the output section 14 outputs, for each operator, a graph indicating the unsafe action which occurred and the number of occurrences. For example, the graph illustrated in the upper part of FIG. 18 indicates that an operator 1 has carried out an unsafe action “exceeding load” once, an unsafe action “invalidating safety device” three times, and an unsafe action “using undesignated device” twice.

As another example, the output section 14 outputs, for each unsafe action, a graph indicating the number of times that an operator has carried out the unsafe action, as illustrated in the lower part of FIG. 18. For example, the diagram illustrated in the lower part of FIG. 18 indicates that an unsafe action “invalidating safety device” has been carried out three times by an operator 1, once by an operator 2, once by an operator 3, and once by an operator 4.

(Effect of Information Processing Apparatus 2)

The information processing apparatus 2 according to the present example embodiment employs the configuration of including: the detection section 11 that detects an operator and an operation object based on an image; the recognition section 12 that recognizes an operation of the operator based on a relevance between the operator and the operation object; and the generation section 13 that generates unsafety information pertaining to unsafety of the operation with reference to a detection result by the detection section 11 and a recognition result by the recognition section 12.

As such, according to the information processing apparatus 2 of the present example embodiment, unsafety information pertaining to unsafety of the recognized operation is generated. Therefore, it is possible to improve safety of an operation of an operator.

(Variation of Detection Section 11)

The detection section 11 may detect an operator and an operation object using a machine learning model. The following description will discuss annotation information that is used in machine learning of a machine learning model, in a case where the detection section 11 uses the machine learning model.

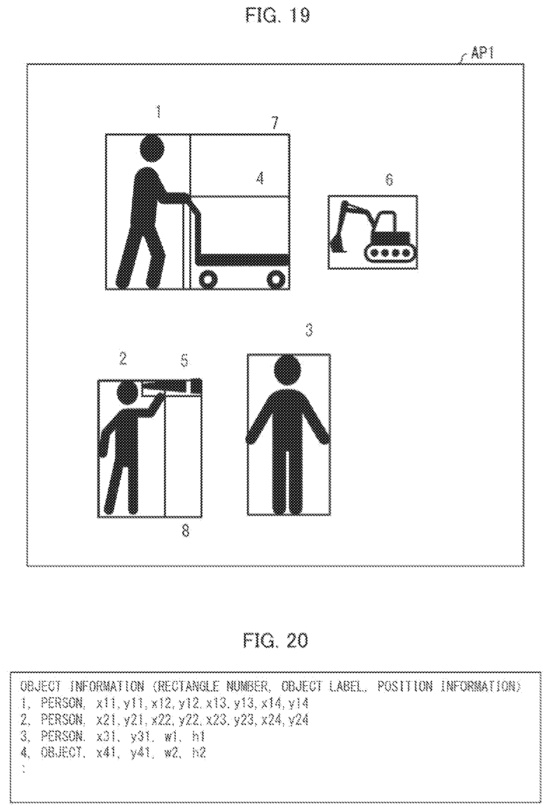

The machine learning model used by the detection section 11 is trained using annotation information in which sensor information is paired with information that indicates a person and an object indicated by the sensor information. The following description will discuss, with reference to FIGS. 19 and 20, an example case where an image is used as sensor information. FIG. 19 is a diagram illustrating an example of an image AP1 which is included in annotation information according to the present variation. FIG. 20 is a diagram illustrating an example of information indicating a person and an object included in annotation information according to the present variation.

As illustrated in FIG. 19, in the image AP1 included in the annotation information, rectangle numbers are respectively assigned to circumscribed rectangles of persons and objects which are included in the image AP1 as subjects. For example, a rectangle number “1” is assigned to a circumscribed rectangle of a person pushing a handcart, and a rectangle number “4” is assigned to a circumscribed rectangle of the handcart.

Next, as illustrated in FIG. 20, information indicating the person and the object included in the annotation information is associated with a rectangle number, an object label indicating whether a person or an object is included in a circumscribed rectangle with the rectangle number, and position information indicating a position of the circumscribed rectangle. For example, a rectangle number “1” which indicates a circumscribed rectangle of a person pushing a handcart is associated with an object label “person” and position information “x11, y11, x12, y12, x13, y13, x14, y14” which indicate positions of four corners of the circumscribed rectangle.

The position information can be represented by information indicating a position of any of the four corners of the circumscribed rectangle and a width and a height of the circumscribed rectangle. For example, as illustrated in FIG. 20, a rectangle number “4”, which indicates a circumscribed rectangle of the handcart, is associated with an object label “object” and with, as position information, “x41, y41” indicating a position of any of four corners of the circumscribed rectangle and a width “w2” and a height “h2” of the circumscribed rectangle.

By thus training the machine learning model used by the detection section 11 with annotation information in which sensor information is paired with information indicating a person and an object indicated by the sensor information, it is possible to train the machine learning model with higher accuracy.

(Variation of Recognition Section 12)

The recognition section 12 may recognize, using an inference model, an action of an operator detected by the detection section 11.

An example of an inference model used by the recognition section 12 is a model into which information indicating a feature of a person and information pertaining to an object are input and from which information indicating a relevance between the person and the object in a predetermined action is output.

In this configuration, the recognition section 12 inputs, into the inference model, information indicating a feature of an operator detected by the detection section 11 and information pertaining to an object detected by the detection section 11. Then, the recognition section 12 recognizes an action of an operator with reference to information that has been output from the inference model and that indicates a relevance between the person and the object in the predetermined action.

For example, in a case where information which has been output from the inference model and which indicates a relevance between a person and an object indicates a fact that the person is related to the object, the recognition section 12 recognizes that the person is carrying out an action using the object. For example, in a case where information which has been output from the inference model and which indicates a relevance between a person and an object indicates a fact that a certain person is related to a handcart, the recognition section 12 recognizes that an operation of the certain person is an operation “transportation” using the handcart.

As described above, the recognition section 12 recognizes an action of an operator detected by the detection section 11 by using the model into which information indicating a feature of a person and information pertaining to an object are input and from which information indicating a relevance between the person and the object in a predetermined action is output. Therefore, the recognition section 12 can recognize, with higher accuracy, an action of an operator.

(Inference Model Used by Recognition Section 12)

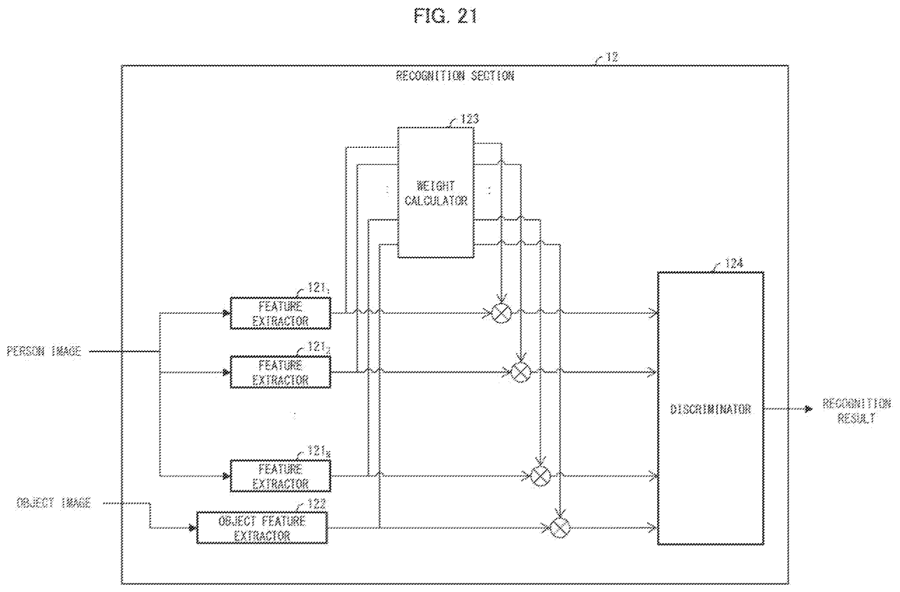

The following description will discuss an example configuration of an inference model used by the recognition section 12, with reference to FIG. 21. FIG. 21 is a diagram illustrating an example configuration of an inference model which is used by the recognition section 12 according to the present variation.

As illustrated in FIG. 21, the recognition section 12 includes a feature extractor 121, an object feature extractor 122, a weight calculator 123, and a discriminator 124.

Into the feature extractor 121, a person image including a person as a subject is input. The feature extractor 121 outputs a feature of the person who is included in the person image as the subject. As illustrated in FIG. 21, the recognition section 12 can be configured to include a plurality of feature extractors 121₁ through 121_{N} that output features of different persons. For example, it is possible to employ a configuration in which the feature extractor 121₁ outputs a feature of a shape of a person who is included in a person image as a subject, and the feature extractor 1212 outputs a feature of a posture of the person who is included in the person image as the subject.

Into the object feature extractor 122, an object image including an object as a subject is input. The object feature extractor 122 outputs information pertaining to the object which is included in the object image as the subject. The information pertaining to the object output by the object feature extractor 122 can be a feature of the object or can be an object name that specifies the object. The object feature extractor 122 can further include, in output information pertaining to an object, position information indicating a position of the object.

The weight calculator 123 gives weights to respective features output from the feature extractors 121₁ through 121_{N}. In other words, the recognition section 12 refers to a plurality of weighed features.

Into the discriminator 124, a feature output from the feature extractor 121 and information pertaining to an object output from the object feature extractor 122 are input, and the discriminator 124 outputs information indicating a relevance between the person and the object in a predetermined action. In other words, the discriminator 124 outputs, based on a feature output from the feature extractor 121 and information pertaining to an object output from the object feature extractor 122, information indicating a relevance between the person and the object in a predetermined action.

As described above, the discriminator 124 may receive, as input, a plurality of features output from the plurality of feature extractors 121₁ through 121_{N}. In other words, the recognition section 12 can be configured to recognize an action of a person based on a relevance between a plurality of features of the person and information pertaining to the object. With this configuration, the recognition section 12 can recognize, with higher accuracy, an action of a person.

(Machine Learning of Inference Model)

The following description will discuss annotation information that is used in machine learning of an inference model used by the recognition section 12.

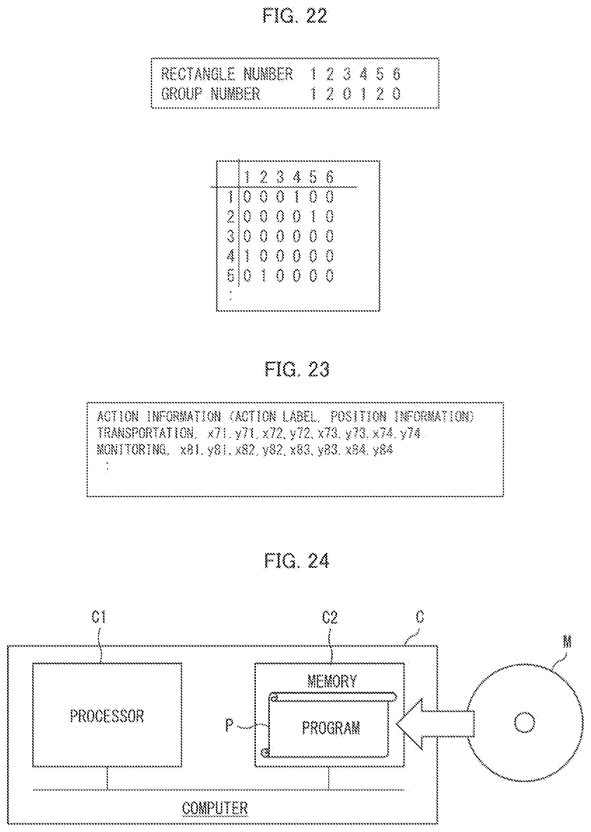

The inference model used by the recognition section 12 is trained using annotation information in which sensor information is paired with relevant information that indicates a relevance between a person and an object indicated by the sensor information. The following description will discuss, with reference to FIGS. 19, 22, and 23, an example case where the foregoing image AP1 indicated in FIG. 19 is used as sensor information. FIG. 22 is a diagram illustrating an example of relevant information which is included in annotation information according to the present variation. FIG. 23 is a diagram illustrating another example of relevant information which is included in annotation information according to the present variation.

As illustrated in FIG. 19, in the image AP1 included in the annotation information, rectangle numbers are respectively assigned to circumscribed rectangles of persons and objects which are included in the image AP1 as subjects. For example, a rectangle number “1” is assigned to a circumscribed rectangle of a person pushing a handcart, and a rectangle number “4” is assigned to a circumscribed rectangle of the handcart. Moreover, as illustrated in FIG. 19, a rectangle number is also assigned to a circumscribed rectangle including a person and an object which are related to each other. For example, a rectangle number “7” is assigned to a circumscribed rectangle including the handcart and the person pushing the handcart.

Next, in the relevant information included in the annotation information, as illustrated in the upper part of FIG. 22, rectangle numbers and group numbers each indicating a relevance are associated with each other. For example, in the upper part of FIG. 22, a rectangle number “1” indicating a person pushing a handcart and a rectangle number “4” indicating the handcart are related to each other, and therefore a group number “1” is associated to both of the rectangle numbers.

As illustrated in the lower part of FIG. 22, the relevant information can be in a matrix form. For example, in the lower part of FIG. 22, a value at a position where a column (or row) of the rectangle number “1” indicating a person pushing a handcart and a row (or column) of the rectangle number “4” indicating the handcart intersect with each other is “1” which indicates that there is a relevance.

The relevant information indicating a relevance between a person and an object can be configured to include an action label indicating an action of the person and position information. For example, as illustrated in FIG. 23, the relevant information can be configured to include (i) position information “x71, y71, x72, y72, x73, y73, x74, y74” indicating positions of four corners of a circumscribed rectangle of a person pushing a handcart and the handcart and (ii) an action label “transportation” indicating an operation of the person pushing the handcart.

By thus training the inference model used by the recognition section 12 with annotation information in which sensor information is paired with relevant information indicating a relevance between a person and an object indicated by the sensor information, it is possible to train the inference model with higher accuracy.

(Machine Learning of Detection Model and Inference Model)

The detection section 11 detects a person and an object with reference to a detection model which has been generated by machine learning, and the recognition section 12 recognizes an action with reference to a recognition model which has been generated by machine learning. It is possible to employ a configuration in which the acquisition section acquires feedback information, which is used to retrain one or both of the detection model and the recognition model with respect to output of the unsafety information, and which indicates whether or not the action is an unsafe action.

For example, as illustrated in the lower part of FIG. 17, the output section 14 outputs an image of an operation determined to involve an unsafe action. In a case where the acquisition section 15 has acquired, from a user, feedback information which is for the image and which indicates that an operator in the image is not carrying out the unsafe action, the acquisition section 15 retrains one or both of the detection model and the recognition model using the feedback information.

As another example, as illustrated in the lower part of FIG. 17, the output section 14 outputs an image of an operation determined to involve an unsafe action “exceeding load”. In a case where the acquisition section 15 has acquired, from a user, feedback information which is for the image and which indicates that an operator in the image is not carrying out the unsafe action “exceeding load” but is carrying out an unsafe action “exceeding loading height”, the acquisition section 15 retrains one or both of the detection model and the recognition model using the feedback information.

As described above, the detection section 11 detects a person and an object with reference to a detection model which has been generated by machine learning, and the recognition section 12 recognizes an action with reference to a recognition model which has been generated by machine learning. Then, the acquisition section 15 acquires feedback information, which is used to retrain one or both of the detection model and the recognition model with respect to output of the unsafety information, and which indicates whether or not the action is an unsafe action. Therefore, the acquisition section 15 can train the detection model and the recognition model with higher accuracy.

### Software Implementation Example

The functions of part of or all of the information processing apparatuses 1 and 2 can be realized by hardware such as an integrated circuit (IC chip) or can be alternatively realized by software.

In the latter case, each of the information processing apparatuses 1 and 2 is realized by, for example, a computer that executes instructions of a program that is software realizing the foregoing functions. FIG. 24 illustrates an example of such a computer (hereinafter, referred to as “computer C”). The computer C includes at least one processor C1 and at least one memory C2. The memory C2 stores a program P for causing the computer C to function as the information processing apparatuses 1 and 2. In the computer C, the processor C1 reads the program P from the memory C2 and executes the program P, so that the functions of the information processing apparatuses 1 and 2 are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

Some of or all of the foregoing example embodiments can also be described as below. Note, however, that the present invention is not limited to the following supplementary notes.

(Supplementary Note 1)

An information processing apparatus, comprising: a detection means of detecting a person and an object based on sensor information; a recognition means of recognizing an action of the person based on a relevance between the person and the object; and a generation means of generating unsafety information pertaining to unsafety of the action with reference to a detection result by the detection means and a recognition result by the recognition means.

(Supplementary Note 2)

The information processing apparatus according to supplementary note 1, in which: the detection means detects one or more persons and one or more objects; the recognition means recognizes, based on a relevance between a first person among the one or more persons and a first object among the one or more objects, an action of the first person; and in a case where the generation means has determined, based on the detection result, that an unsafety condition is satisfied, the generation means generates the unsafety information, the unsafety condition being associated with an action indicated by the recognition result, and being related to a second person different from the first person or a second object different from the first object.

(Supplementary Note 3)

The information processing apparatus according to supplementary note 2, in which: the second object is an object to be subjected to the action; the generation means extracts a feature of the second object based on the detection result; and in a case where an unsafety condition related to the feature of the second object is satisfied, the generation means generates unsafety information.

(Supplementary Note 4)

The information processing apparatus according to supplementary note 2 or 3, in which: the second object is an object that is necessary for safety of the action; and in a case where an unsafety condition that the second object has not been detected is satisfied, the generation means generates unsafety information based on the detection result.

(Supplementary Note 5)

The information processing apparatus according to any one of supplementary notes 2 through 4, in which: the second object is an object that is not associated with the action; and in a case where an unsafety condition that the second object has been detected is satisfied, the generation means generates unsafety information based on the detection result.

(Supplementary Note 6)

The information processing apparatus according to supplementary note 5, in which: in a case where an unsafety condition that the second person is using or wearing the second object is satisfied, the generating means generates unsafety information based on the detection result.

(Supplementary Note 7)

The information processing apparatus according to any one of supplementary notes 2 through 6, in which: in a case where an unsafety condition that the second person has been detected in a predetermined range from the first object is satisfied, the generation means generates unsafety information based on the detection result.

(Supplementary Note 8)

The information processing apparatus according to any one of supplementary notes 2 through 7, in which: in a case where an unsafety condition that the second person is approaching or has entered a dangerous region which is specified by the second object is satisfied, the generating means generates unsafety information based on the detection result.

(Supplementary Note 9)

The information processing apparatus according to any one of supplementary notes 1 through 8, further including: an output means of outputting the unsafety information.

(Supplementary Note 10)

The information processing apparatus according to supplementary note 9, in which: the detection means detects the person and the object with reference to a detection model which has been generated by machine learning; the recognition means recognizes the action with reference to a recognition model which has been generated by machine learning; and the information processing apparatus further comprises an acquisition means of acquiring feedback information, the feedback information being used to retrain one or both of the detection model and the recognition model with respect to output of the unsafety information, and the feedback information indicating whether or not the action is an unsafe action.

(Supplementary Note 11)

An information processing method, including: detecting, by an information processing apparatus, a person and an object based on sensor information; recognizing, by the information processing apparatus, an action of the person based on a relevance between the person and the object; and generating, by the information processing apparatus, unsafety information pertaining to unsafety of the action with reference to a detection result in the detecting and a recognition result in the recognizing.

(Supplementary note 12)

A program for causing a computer to function as an information processing apparatus, the program causing the computer to function as: a detection means of detecting a person and an object based on sensor information; a recognition means of recognizing an action of the person based on a relevance between the person and the object; and a generation means of generating unsafety information pertaining to unsafety of the action with reference to a detection result by the detection means and a recognition result by the recognition means.

(Supplementary Note 13)

An information processing apparatus, including at least one processor, the at least one processor carrying out: a detection process of detecting a person and an object based on sensor information; a recognition process of recognizing an action of the person based on a relevance between the person and the object; and a generation process of generating unsafety information pertaining to unsafety of the action with reference to a detection result in the detection process and a recognition result in the recognition process.

Note that the information processing apparatus can further include a memory. The memory can store a program for causing the processor to carry out the detection process, the recognition process, and the generation process. The program can be stored in a computer-readable non-transitory tangible storage medium.

### REFERENCE SIGNS LIST

1, 2: Information processing apparatus
11: Detection section
12: Recognition section
13: Generation section
14: Output section
15 Acquisition section
100: Information processing system

1. An information processing apparatus, comprising at least one processor, the at least one processor carrying out:
a detection process of detecting a person and an object based on sensor information;
a recognition process of recognizing an action of the person based on a relevance between the person and the object; and
a generation process of generating unsafety information pertaining to unsafety of the action with reference to a detection result in the detection process and a recognition result in the recognition process.

2. The information processing apparatus according to claim 1, wherein:
in the detection process, the at least one processor detects one or more persons and one or more objects;
in the recognition process, the at least one processor recognizes, based on a relevance between a first person among the one or more persons and a first object among the one or more objects, an action of the first person; and
in the generation process, in a case where the at least one processor has determined, based on the detection result, that an unsafety condition is satisfied, the at least one processor generates the unsafety information, the unsafety condition being associated with an action indicated by the recognition result, and being related to a second person different from the first person or a second object different from the first object.

3. The information processing apparatus according to claim 2, wherein:
the second object is an object to be subjected to the action;
in the generation process, the at least one processor extracts a feature of the second object based on the detection result; and
in the generation process, in a case where an unsafety condition related to the feature of the second object is satisfied, the at least one processor generates unsafety information.

4. The information processing apparatus according to claim 2, wherein:
the second object is an object that is necessary for safety of the action; and
in the generation process, in a case where an unsafety condition that the second object has not been detected is satisfied, the at least one processor generates unsafety information based on the detection result.

5. The information processing apparatus according to claim 2, wherein:
the second object is an object that is not associated with the action; and
in the generation process, in a case where an unsafety condition that the second object has been detected is satisfied, the at least one processor generates unsafety information based on the detection result.

6. The information processing apparatus according to claim 2, wherein:
in the generation process, in a case where an unsafety condition that the second person has been detected in a predetermined range from the first object is satisfied, the at least one processor generates unsafety information based on the detection result.

7. The information processing apparatus according to claim 1, wherein:
the at least one processor further carries out an output process of outputting the unsafety information.

8. The information processing apparatus according to claim 7, wherein:
in the detection process, the at least one processor detects the person and the object with reference to a detection model which has been generated by machine learning;
in the recognition process, the at least one processor recognizes the action with reference to a recognition model which has been generated by machine learning; and
the at least one processor further carries out an acquisition process of acquiring feedback information, the feedback information being used to retrain one or both of the detection model and the recognition model with respect to output of the unsafety information, and the feedback information indicating whether or not the action is an unsafe action.

9. An information processing method, comprising:
detecting, by at least one processor, a person and an object based on sensor information;
recognizing, by the at least one processor, an action of the person based on a relevance between the person and the object; and
generating, by the at least one processor, unsafety information pertaining to unsafety of the action with reference to a detection result in the detecting and a recognition result in the recognizing.

10. A computer-readable non-transitory storage medium storing a program for causing a computer to function as an information processing apparatus, the program causing the computer to carry out:
a detection process of detecting a person and an object based on sensor information;
a recognition process of recognizing an action of the person based on a relevance between the person and the object; and
a generation process of generating unsafety information pertaining to unsafety of the action with reference to a detection result in the detection process and a recognition result in the recognition process.
